(19) United States
(12) Patent Application Publication
(10) Pub. No.: US 2003/0099431 A1
(43) Pub. Date: May 29, 2003

(54) Dense wavelength division multiplexer module

(76) Inventors: Kun-Tsan Wu, Tu-Chen (TW); Chien-Cheng Chen, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/033,346

(22) Filed: Dec. 26, 2001

(30) Foreign Application Priority Data
Nov. 28, 2001 (TW) 90220620

(51) Int. Cl. G02B 6/28; G02B 6/00

(52) U.S. Cl. 385/24; 385/135

(57) ABSTRACT

A DWDM module (10) comprises a cover (1), a base (2), DWDMs (3), retainers (4) retaining the DWDMs therein, heat shrinkage pipes (5), optical fibers (33), and holders (6) holding the heat shrinkage pipes therein. The DWDMs are in communication with each other via the optical fibers. The DWDM module further comprises a rubber loop (7) providing a tight seal between the cover and the base, and a protecting component (8) for protecting the optical fibers. The base comprises a motherboard (26), a peripheral frame (21), spaced projections (22), and an array of arcuate ribs (23). The projections and corresponding sidewalls of the frame fittingly secure the holders therebetween. The array of ribs is upwardly formed from a middle of the motherboard, and fittingly secures the retainers therein. A cutout (212) is integrally defined in the motherboard and one sidewall of the frame, and fittingly secures the protecting device therein.

### BACKGROUND OF THE INVENTION

1. Field of the Invention

The present invention relates to Dense Wavelength Division Multiplexer (DWDM) modules, and more particularly to a DWDM module which has excellent stability and is manufactured easily.

2. Description of Related Art

DWDM systems are widely deployed in modern optical communications networks. In the DWDM system, multiple channels are carried over a single optical fiber without interference between the channels, so that channel-carrying capacity is increased. The DWDM system includes a DWDM module which secures a plurality of DWDMs therein. DWDMs must be properly secured in the DWDM module, to ensure reliability and durability of the DWDM module. Various DWDM modules have been developed for the optical communications industry.

A conventional DWDM module uses epoxy to secure DWDMs therein. Generally, heat must be applied to the epoxy to cure it. This is unduly time-consuming. Furthermore, the heat can alter the dimensions of components in the DWDM module, which may adversely affect the optical characteristics of the module. Thus, this kind of DWDM module is not favored in the industry.

Recently, plastic hooks have been used to fix DWDMs in a DWDM module. The plastic hooks can be secured in short time, and do not affect the optical characteristics of the module. Nevertheless, the plastic hooks are extra components that increase costs.

Thus, it is desired to provide an inexpensive DWDM module which is easily manufactured and which has excellent stability.

### SUMMARY OF THE INVENTION

An object of the present invention is to provide a DWDM module which has excellent stability.

Another object of the present invention is to provide a DWDM module which is easily manufactured.

To achieve the above objects, a DWDM module of the present invention comprises a cover, a base, a plurality of DWDMs, a plurality of retainers retaining DWDMs therein, a plurality of heat shrinkage pipes, a plurality of optical fibers, and a plurality of holders holding the heat shrinkage pipes therein. The DWDMs are in communication with each other via the optical fibers. The DWDM module further comprises a rubber loop providing a tight seal between the cover and the base, and a protecting component for protecting the optical fibers. The base comprises a motherboard, a peripheral frame, a plurality of spaced projections, and an array of arcuate ribs. The projections and corresponding sidewalls of the frame fittingly secure the holders therebetween. The array of ribs is upwardly formed from a middle portion of the motherboard, and fittingly secures the retainers therein. A cutout is integrally defined in the motherboard and one sidewall of the frame, and fittingly secures the protecting device therein.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is an exploded view of a DWDM module in accordance with the present invention;

FIG. 2 is an exploded view of a DWDM and a retainer of the DWDM module of FIG. 1;

FIG. 3 is an assembled view of FIG. 2;

FIG. 4 is an exploded view of a heat shrinkage pipe retaining optical fibers therein and of a holder, all being of the DWDM module of FIG. 1;

FIG. 5 is an assembled view of FIG. 4;

FIG. 6 is a perspective view of a base of the DWDM module of FIG. 1, and a protecting component thereof secured in the base; and

FIG. 7 is a top plan view of the DWDM module of FIG. 1 fully assembled, but with a cover thereof removed.

### DETAILED DESCRIPTION OF PREFERRED EMBODIMENT

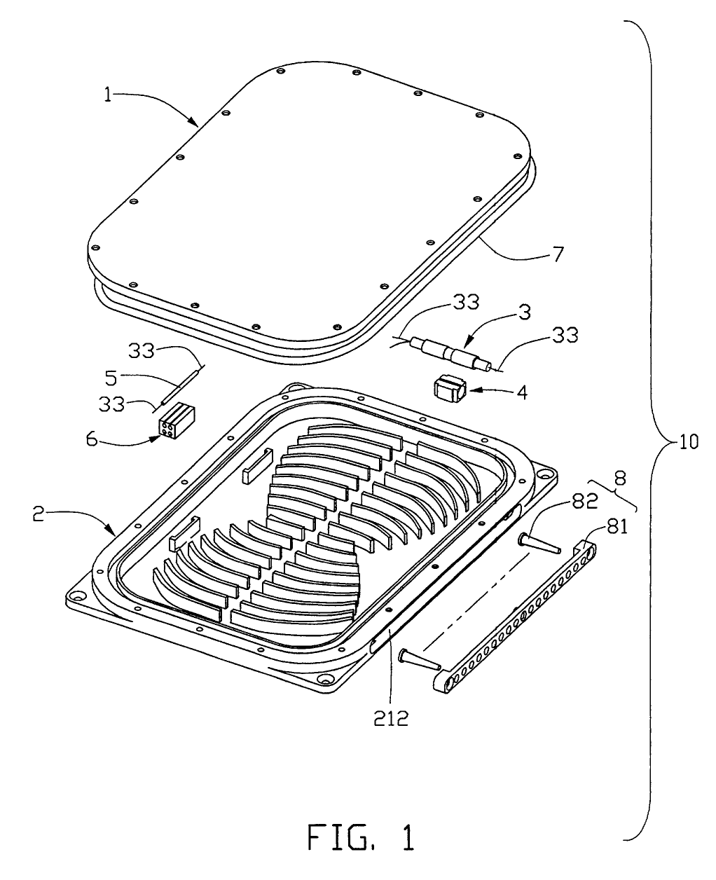

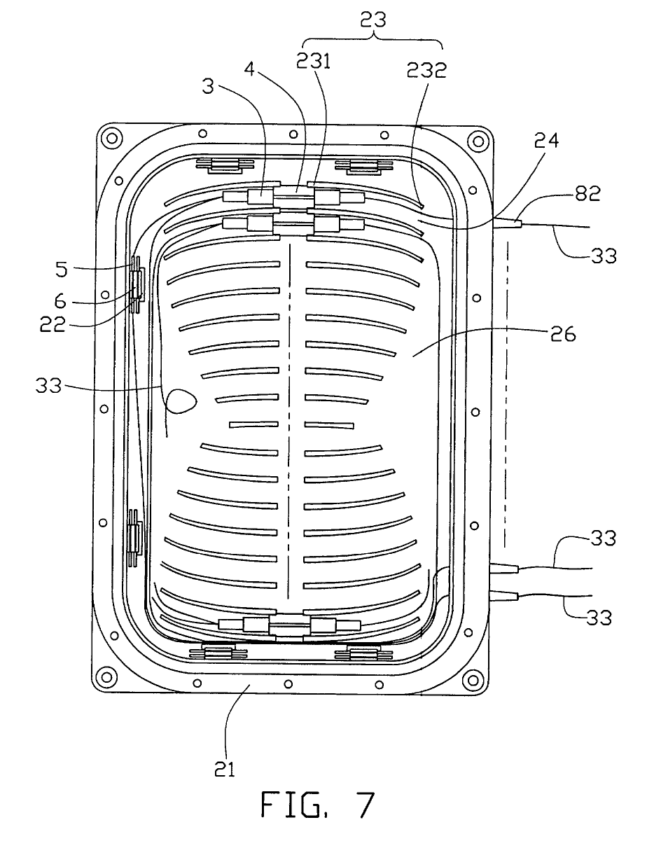

Referring to FIGS. 1 and 7, a DWDM module 10 in accordance with the present invention comprises a cover 1, a base 2, a plurality of DWDMs 3, a plurality of retainers 4 for retaining the DWDMs 3 therein, a plurality of heat shrinkage pipes 5, a plurality of holders 6 for holding the heat shrinkage pipes 5 therein, and a plurality of optical fibers 33. The DWDMs are in communication with each other via the optical fibers 33. The DWDM module 10 further comprises a rubber loop 7 and an elongate protecting component 8 for protecting the optical fibers 33. The rubber loop 7 provides a tight seal between the cover 1 and the base 2.

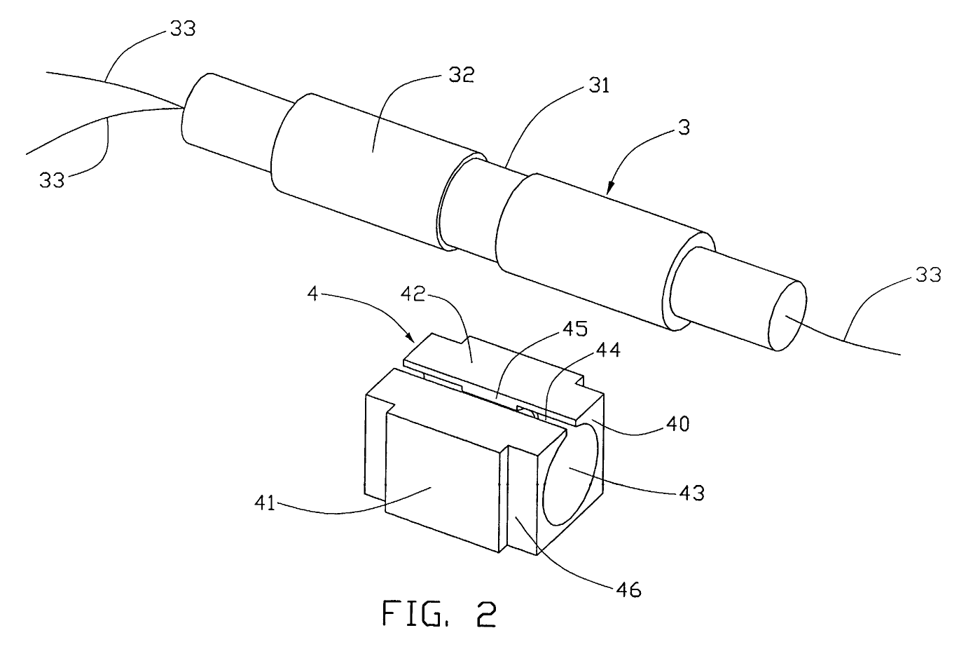

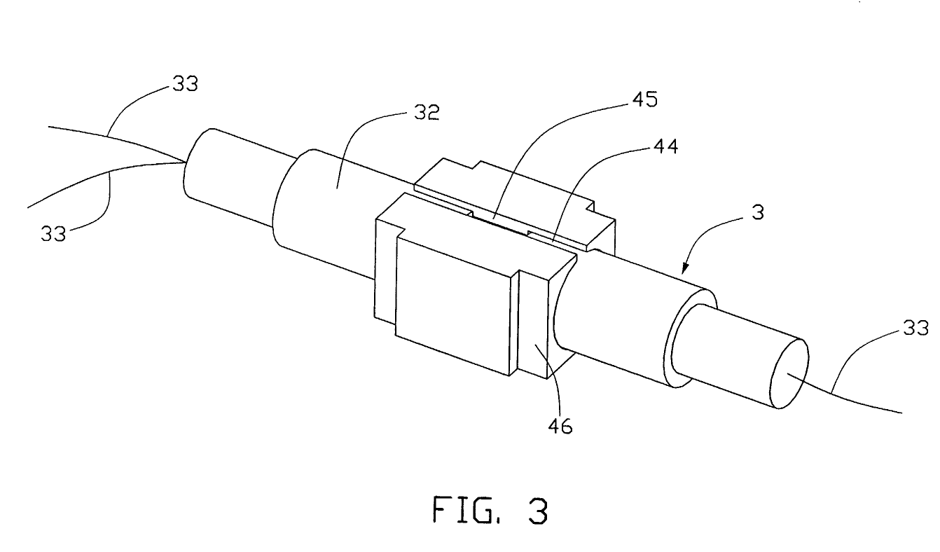

Referring to FIGS. 2 and 3, each DWDM 3 has a sleeve 32 defining an outer circumferential groove 31 in a middle portion thereof. Each retainer 4 is made of elastic material, such as rubber or plastic. The retainer 4 generally has a box-shaped configuration comprising two opposite end surfaces 40, two opposite sidewalls 41, a top surface 42 and a bottom surface (not visible). A C-shaped passage 43 is defined in the retainer 4, for retaining the sleeve 32 of a corresponding DWDM 3 therein. The passage 43 of the retainer 4 has a generally circular profile. A diameter of the circular profile is substantially equal to a diameter of each sleeve 32. A C-shaped bead 45 is formed in a middle portion of the passage 43, for being received in the groove 31 of the corresponding sleeve 32. A uniform width of the bead 45 is substantially equal to a uniform width of the groove 31. An entrance 44 is defined in the top surface 42, in communication with the passage 43. A width of the entrance 44 is less than the diameter of the passage 43. Two steps 46 are formed in the retainer 4 at opposite ends of each sidewall 41 respectively.

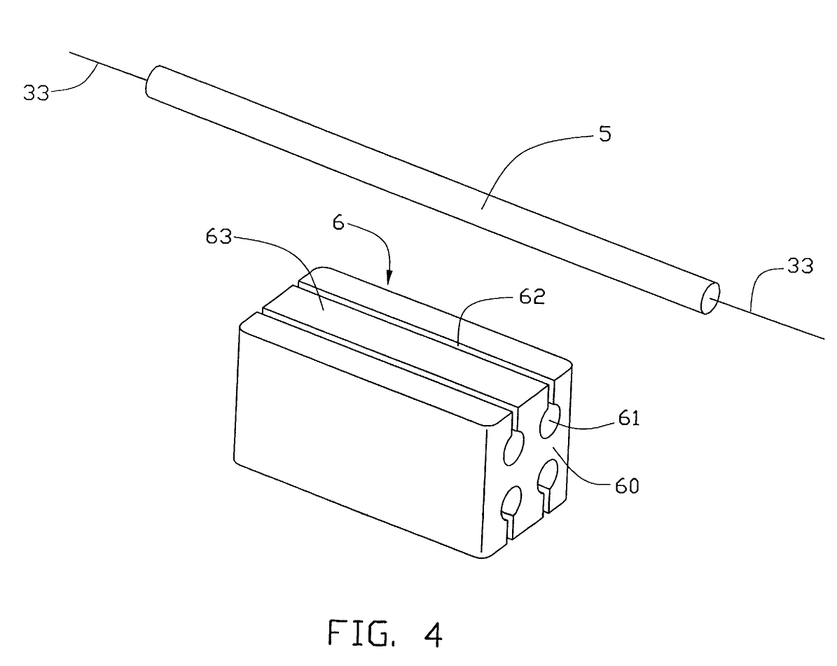

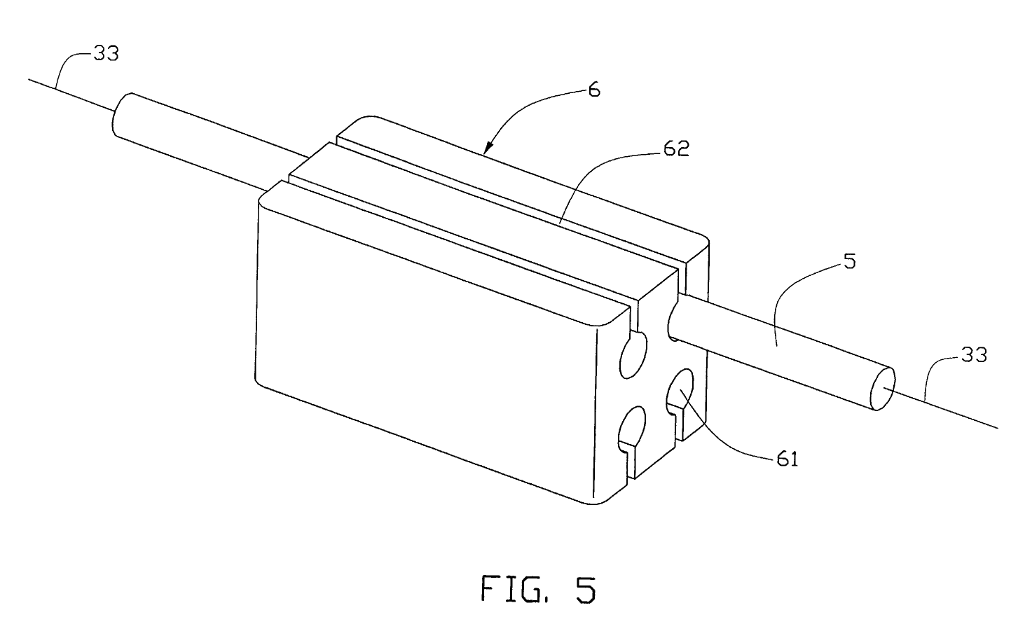

Referring to FIGS. 4 and 5, each heat shrinkage pipe 5 seals a region where two optical fibers 33 are spliced together. Each holder 6 generally has a box-shaped configuration, and is made of elastic material such as plastic or rubber. The holder 6 comprises two opposite end surfaces 60, two opposite sidewalls (not labeled), a top surface 63 and a bottom surface (not visible). Four parallel passageways 61 are defined in the holder 6. Each passageway 61 has a generally circular profile. A diameter of the circular profile is substantially equal to a diameter of each heat shrinkage pipe 5. Two parallel entranceways 62 are defined in the top surface 63, and two parallel entranceways 62 are defined in the bottom surface of the holder 6. Each entranceway 62 is parallel to and in communication with a corresponding passageway 61. A width of the entranceway 62 is less than the diameter of the passageway 61.

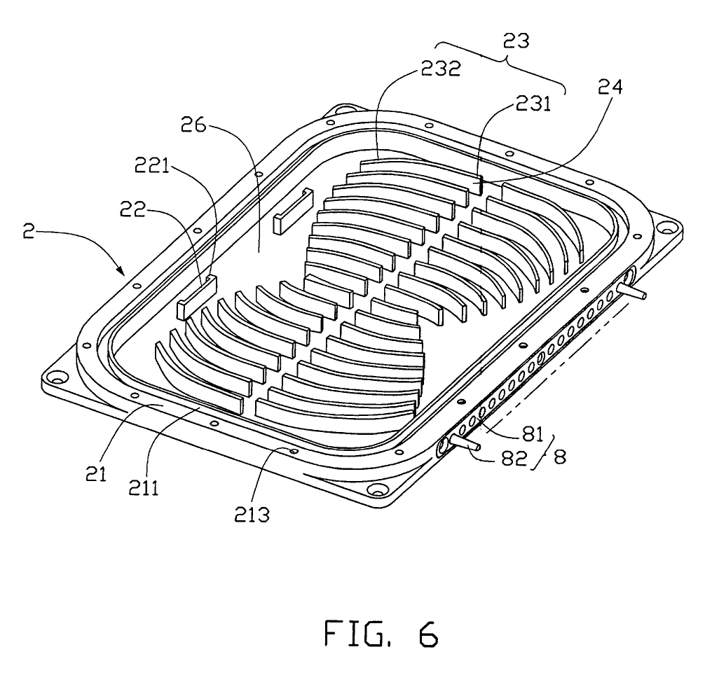

Referring to FIGS. 1, 6 and 7, the base 2 comprises a rectangular motherboard 26, a peripheral frame 21 upwardly formed at four edges of the motherboard 26, six spaced projections 22 formed at three of four edges of the motherboard 26, and an array of arcuate ribs 23. A peripheral recess 211 is defined in a top surface of the frame 21, for fittingly securing the rubber loop 7 therein. A plurality of screw holes 213 is defined in the top surface of the frame 21 around a periphery of the recess 211, for engagingly receiving screws (not shown). A cutout 212 is integrally defined in the motherboard 26 and one longitudinal sidewall of the frame 21, for fittingly securing the protecting component 8 therein.

The six projections 22 are disposed close to and inwardly from three corresponding sidewalls of the frame 21. Each projection 22 comprises a main portion (not labeled), and two end portions 221 perpendicularly extending from respective opposite ends of the main portion toward a proximate sidewall of the corresponding sidewalls of the frame 21. A distance between the two end portions 221 is substantially equal to a length of each holder 6. A distance between the main portion of the projection 22 and the proximate sidewall of the frame 21 is substantially equal to a width of each holder 6. Accordingly, each holder 6 can be fittingly secured in a space defined between the end portions 221 and the main portion of a corresponding projection 22, and the proximate sidewall of the frame 21.

The array of ribs 23 is upwardly formed from a middle portion of the motherboard 26. The array of ribs 23 comprises two symmetrically opposite sets of ribs 23. Each set of ribs 23 comprises nine pairs of ribs 23. The ribs 23 in each pair of ribs 23 are generally in alignment with each other. The pairs of ribs 23 in each set of ribs 23 are generally parallel to each other, and evenly spaced apart. Eight channels 24 are thereby interleavingly defined between the nine pairs of ribs 23, for retainingly receiving the retainers 4 therein. Each rib 23 comprises a generally straight inmost end 231 and an arcuate outmost end 232. A distance between the inmost ends 231 in each pair of ribs 23 is substantially equal to a distance between opposite ends of each sidewall 41 of each retainer 4 between the corresponding steps 46. A width of each channel 24 between adjacent inmost ends 231 in the array of ribs 23 is substantially equal to a distance between outmost faces of two directly opposite steps 46 at respective opposite sidewalls 41 of each retainer 4.

The protecting component 8 comprises an elongate holding frame 81, and a plurality of strain relief boots 82. The holding frame 81 defines a plurality of through holes (not labeled) therein. Each strain relief boot 82 is retained in a corresponding through hole of the holding frame 81, for protecting optical fibers 33 therein.

Referring to FIGS. 1-7, in assembly, each DWDM 3 is pressed into a corresponding retainer 4. The sleeve 32 of the DWDM 3 is passed through the entrance 44 and received in the passage 43 of the retainer 4. The bead 45 of the retainer 4 is fittingly received in the groove 31 of the DWDM 3. Thus the sleeve 32 is prevented from moving in longitudinal directions in the passage 43. The sleeve 32 is easily, securely, and reliably retained in the retainer 4. Each combined retainer 4 and DWDM 3 is fittingly received in a corresponding channel 24 of the array of ribs 23, generally between the four end portions 231 of two corresponding pairs of ribs 23. Thus the retainer 4 is easily, securely, and reliably retained in the base 2. The DWDMs 3 are in communication with each other via the optical fibers 33. Some of the optical fibers 33 are extended through the cutout 212 of the base 2 and through corresponding strain relief boots 82 of the protecting component 8, for communication with complementary optical devices (not shown). Each strain relief boot 82 is fittingly secured in a corresponding through hole of the holding frame 81 of the protecting component 8. The protecting component 8 is then fittingly secured in the cutout 212 of the base 2. Some other of the optical fibers 33 are spliced, and then secured in corresponding heat shrinkage pipes 5. Each heat shrinkage pipe 5 is pressed into a corresponding passageway 61 of a corresponding holder 6. Therefore, each heat shrinkage pipe 5 is fittingly secured in the corresponding passageway 61. Each holder 6 can accommodate up to four shrinkage pipes 5 therein. Each holder 6 is then pressed into the space defined between a corresponding projection 22 and the proximate sidewall of the frame 21. Thus each holder 6 is fittingly secured in the corresponding space.

The rubber loop 7 is then fittingly secured in the recess 211 of the base 2. The cover 1 is then secured to the base 2, thereby pressing the retainers 4 and the holders 5 and preventing them from moving vertically. Simultaneously, the cover 1 presses the rubber loop 7, thereby providing a tight seal between the cover 1 and the base 2. Finally, the screws (not shown) are inserted through apertures (not labeled) of the cover 1 to engaging in the screw holes 213 of the base 2. The cover 1 and the base 2 are thereby firmly secured together.

Although the present invention has been described in specific terms, it should be noted that the described embodiment is not necessarily exclusive, and that various changes and modifications may be made thereto without departing from the scope of the present invention as defined in the appended claims.

What is claimed is:

1. A dense wavelength division multiplexer module comprising:
a plurality of dense wavelength division multiplexers, each of the dense wavelength division multiplexers comprising a sleeve;
a plurality of optical fibers communicating between the dense wavelength division multiplexers;
a plurality of retainers, each of the retainers retaining the sleeve of a corresponding dense wavelength division multiplexer therein; and
supporting means comprising an array of ribs, the array of ribs comprising at least three pairs of ribs, a plurality of channels being thereby interleavingly defined between the pairs of the ribs;
wherein each of the retainers is secured in a corresponding channel between two corresponding pairs of the ribs.

2. The dense wavelength division multiplexer module in accordance with claim 1, wherein the ribs in each pair of the ribs are generally aligned with each other, each pair of the ribs is generally parallel to an adjacent pair of the ribs, and the pairs of the ribs are evenly spaced apart.

3. The dense wavelength division multiplexer module in accordance with claim 2, wherein each of the retainers comprises two opposite sidewalls, and two steps are formed in the retainer at opposite ends of each of the sidewalls respectively, and each of the ribs comprises a generally straight inmost end and an arcuate outmost end, a distance between the inmost ends in each pair of the ribs is substantially equal to a distance between opposite ends of each of the sidewalls of each of the retainers between two corresponding steps, a width of each of the channels between adjacent inmost ends is substantially equal to a distance between outmost faces of two directly opposite steps at respective opposite sidewalls of each of the retainers.

4. A dense wavelength division multiplexer module comprising:
a plurality of dense wavelength division multiplexers;
a plurality of optical fibers communicating between the dense wavelength division multiplexers; and
supporting means comprising an array of ribs;
wherein the dense wavelength division multiplexers are secured in the array of ribs.

5. The dense wavelength division multiplexer module in accordance with claim 4, further comprising a plurality of retainers; wherein each of the dense wavelength division multiplexers comprises a sleeve, each of the retainers retains the sleeve of a corresponding dense wavelength division multiplexer therein, and the retainers are secured in the array of ribs.

6. The dense wavelength division multiplexer module in accordance with claim 4, further comprising a plurality of heat shrinkage pipes and a plurality of holders, each of the heat shrinkage pipes retaining optical fibers therein, each of the holders holding at least one heat shrinkage pipe therein.

7. The dense wavelength division multiplexer module in accordance with claim 5, wherein each of the retainers defines a passage, a diameter of said passage is substantially equal to a diameter of the sleeve of each of the dense wavelength division multiplexers, and each of the dense wavelength division multiplexers is retained in said passage of a corresponding retainer.

8. The dense wavelength division multiplexer module in accordance with claim 5, wherein each of the retainers forms a C-shaped bead in said passage, each of the sleeves of the dense wavelength division multiplexers defines a circumferential groove, and the groove engagingly receives the C-shaped bead of a corresponding retainer.

9. The dense wavelength division multiplexer module in accordance with claim 7, wherein each of the retainers defines an entrance in a top surface thereof, and said entrance communicates with said passage of the retainer.

10. The dense wavelength division multiplexer module in accordance with claim 5, wherein each of the retainers comprises two opposite sidewalls, and two steps are formed in the retainer at opposite ends of each of the sidewalls respectively.

11. The dense wavelength division multiplexer module in accordance with claim 6, wherein each of the holders defines a plurality of passages parallel to each other, a diameter of each of said passages is substantially equal to a diameter of each of the heat shrinkage pipes; and each of the heat shrinkage pipes is retained in a corresponding said passage of a corresponding holder.

12. The dense wavelength division multiplexer module in accordance with claim 11, wherein each of the holders defines a plurality of parallel entrances therein, and each of said entrances is in communication with a corresponding said passage of the holder.

13. The dense wavelength division multiplexer module in accordance with claim 4, wherein the supporting means further comprises a cover and a base, and the cover is secured on the base.

14. The dense wavelength division multiplexer module in accordance with claim 13, further comprising a rubber loop secured between the cover and the base.

15. The dense wavelength division multiplexer module in accordance with claim 14, wherein the base comprises a motherboard and a peripheral frame upwardly formed at four edges of the motherboard, the array of ribs is upwardly formed from the motherboard, the frame defines a peripheral recess therein, and the rubber loop is secured in the recess and pressed by the cover to provide a tight seal between the cover and the base.

16. The dense wavelength division multiplexer module in accordance with claim 15, wherein a sidewall of the frame defines a cutout, and at least one of the optical fibers is extended through the cutout.

17. The dense wavelength division multiplexer module in accordance with claim 16, further comprising a protecting component retained in the cutout of the frame of the base, the protecting component comprising an elongate holding frame and a plurality of strain relief boots, the holding frame defining a plurality of through holes therein, and wherein each of the strain relief boots has a corresponding optical fiber extending therethrough, and is secured in a corresponding through hole.

18. The dense wavelength division multiplexer module in accordance with claim 15, wherein the motherboard of the base forms a plurality of projections disposed close to corresponding sidewalls of the frame, each of the projections comprises a main portion and two end portions perpendicularly extending from opposite ends of the main portion toward a proximate one of the corresponding sidewalls of the frame, and each of the holders is secured in a space defined between the end portions and the main portion of a corresponding projection, and the proximate sidewall of the frame.

19. The dense wavelength division multiplexer module in accordance with claim 10, wherein the array of ribs comprises at least three pairs of ribs, the ribs in each pair of the ribs are generally aligned with each other, each pair of the ribs is generally parallel to an adjacent pair of the ribs, the pairs of the ribs are evenly spaced apart, a plurality of channels is thereby interleavingly defined between the pairs of the ribs, and each of the retainers is securely retained in a corresponding channel between two corresponding pairs of the ribs.

20. The dense wavelength division multiplexer module in accordance with claim 19, wherein each of the ribs comprises a generally straight inmost end and an arcuate outmost end, a distance between the inmost ends in each pair of the ribs is substantially equal to a distance between opposite ends of each of the sidewalls of each of the retainers between two corresponding steps, and a width of each of the channels between adjacent inmost ends is substantially equal to a distance between outmost faces of two directly opposite steps at respective opposite sidewalls of each of the retainers.

21. A dense wavelength division multiplexer module comprising:
a plurality of dense wavelength division multiplexers, each of said dense wavelength division multiplexers comprising a sleeve;
a plurality of optical fibers communicating between the dense wavelength division multiplexers;
a plurality of retainers holding said sleeves of said dense wavelength division multiplexers in position in an interior area of the module;
a plurality of holders retaining a plurality of shrinkage pipes in a periphery of said module; wherein
each of said shrinkage pipes seals a region where two of said optical fibers spliced together.
